(19) United States
(12) Patent Application Publication
(10) Pub. No.: US 2013/0316056 A1
(43) Pub. Date: Nov. 28, 2013

(54) Process For Producing Cacao Puree Of High Purity And Yield

(71) Applicants: Rafael Parducci, Guayaquil (EC); Joseph W. Montgomery, Weston, FL (US)

(72) Inventors: Rafael Parducci, Guayaquil (EC); Joseph W. Montgomery, Weston, FL (US)

(21) Appl. No.: 13/887,061

(22) Filed: May 3, 2013

Related U.S. Application Data
(60) Provisional application No. 61/642,128, filed on May 3, 2012.

(51) Int. Cl. A23G 1/00

(52) U.S. Cl. CPC A23G 1/0009
USPC 426/393

(57) ABSTRACT

A process for producing cacao puree of high purity and yield involves steps of opening a cacao pod in a sanitary facility; promptly removing cacao seeds and cacao pulp and mucilage from the cacao pod; promptly separating 60%-98% of the cacao pulp and mucilage from the cacao seeds in a mechanical separator which sieves the pulp and mucilage to form a cacao puree; promptly collecting the cacao puree and placing it in a container; and promptly freezing the cacao puree to form a frozen cacao puree. The frozen cacao puree can be thawed and pasteurized for use in a beverage or other food product.

### FIELD OF THE INVENTION

The present invention relates to a process for producing cacao puree of high purity and yield.

### BACKGROUND OF THE INVENTION

Theobroma cacao, also known as cacao tree, is a small tree in the family Sterculiaceae (alternatively Malvaceae) which is found in South America and other locations. A cacao tree produces about 20 usable pods a year. The cacao pods contain seeds surrounded by pulp and mucilage. The cacao seeds are the main ingredient of chocolate. Given the value and great demand of the cacao seeds, the harvesting and processing of cacao is mainly focused on minimizing damage to the cacao seeds, while very little care and attention is paid to the pulp and mucilage surrounding the seeds.

Traditionally, cacao pods are removed from the trees and are immediately cut in half using machetes. The seed bunch is saved, while the husk and stem are discarded. Portions of the pulp and juice may be consumed by the farm workers during the harvest or it will be drained onto the ground. The seed bunch, i.e., the seeds covered with pulp and mucilage, is collected and transported in mesh bags and the pulp and mucilage dehydrates and/or seeps out. The cacao seeds are then fermented. During the fermentation process, fresh cacao beans and the pulp and mucilage are placed in large, shallow, heated trays or heated by the sun; and may be covered with large banana leaves. Fermenting beans are periodically stirred to provide even fermentation of the seeds.

Fermentation is a critical process that develops the chocolate flavor of the beans, as it removes the raw, bitter taste of cacao. During the fermentation process, sugars are converted to acid, primarily lactic and acetic acids that change the chemical composition of the beans. The acetic acid breaks down the cell walls of the seeds, allowing previously separated substances to mix. Chemical changes that take place within the bean include enzyme activity, oxidation, and the breakdown of proteins into amino acids. During fermentation, the pulp and mucilage typically dries up and is removed from the seeds.

The fermentation process traditionally has been an inexact process in which each batch is different. The fermentation depends on many factors including pod ripeness, storage, pod diseases, variations in the pulp/bean ratio, size of the batch, season, weather conditions, the turning frequency or absence of turning, fermentation time, etc., which makes reproducibility of fermentation particularly difficult. The uncontrolled nature of the usual fermentation process causes the quality of the cacao beans to vary.

After fermentation, the cacao seeds are dried in trays in the sun. The drying process usually takes about a week and results in seeds that are about half of their original weight. The dried cacao seeds are typically called cacao beans or cocoa beans at this stage.

Cacao beans are then typically cleaned, mixed into a desired blend, and fragmented, and their husks are removed. The remaining inner part of the kernel, called ‘nib’ is heat-treated to eliminate possible bacteria, then roasted and ground into a liquid cocoa mass. The nibs are alkalized before, during or after the roasting process. This determines the color and taste of the cocoa mass, which, as an intermediate or semi finished product, is supplied to the chocolate industry and is also basis for the production of cocoa powder and cocoa butter. One such method of processing cacao seeds is described in U.S. Pat. No. 6,887,501.

It should be noted that the terms “cacao” and “cocoa” are both often used to refer to the same items. For example, cacao beans are often referred to as “cocoa” beans. In the present application, generally the term “cacao” is used to refer to the agricultural materials and “cocoa” is used to refer to products of the roasted cacao nibs.

Cacao pulp and mucilage typically contains 80-90% water, 10-15% sugar, 0.4-2.0% citric acid, 1% pectin and other constituents including pentosans, polyphenols and antioxidants. Cacao pulp and mucilage has both a high polyphenol and antioxidant content, and is sometimes referred to as a “superfood” having significant health benefits. It can be used to make juice, cocoa jelly, alcohol, vinegar and puree. 800 kg of seeds contains approximately 40 liters of pulp and mucilage. However, it has been found that the nutritionally beneficial components of cacao pulp and mucilage such as polyphenols begin to oxidize and degrade as soon as the pulp and mucilage is released from the cacao pod and begins to ferment.

The traditional process of producing cacao seeds is very wasteful of the cacao pulp and mucilage and/or does not preserve the beneficial components of cacao pulp and mucilage. Furthermore, given the problem of immediate product degradation, including loss of nutritionally beneficial components, upon the opening of the cacao pods, agricultural products producers have been unable to provide cacao pulp and mucilage with a reliable, consistent flavor and nutritional profile. There is a potential market in the United States for cacao pulp products having a commercially acceptable, consistent flavor and nutritional profile. However, to the best of our knowledge, there is no commercially acceptable cacao pulp product available in the United States.

It would be desirable to provide a process which efficiently produces cacao pulp puree of high quality and yield with little or no oxidation or other degradation of the nutritionally beneficial components of the cacao pulp and mucilage.

### SUMMARY OF THE INVENTION

A process for producing cacao puree, comprises selecting an adequately ripe and disease-free cacao pod at a cacao plantation and transporting it to a sanitary facility, opening the cacao pod in the sanitary facility; promptly removing cacao seeds and cacao pulp and mucilage from the cacao pod; promptly separating the cacao seeds from the cacao pulp and mucilage in a paddle separator, wherein 60%-98% of the cacao pulp and mucilage is separated from the cacao seeds, and the removed cacao pulp and mucilage is sieved through a cylindrical sieve of the paddle separator to form a cacao puree; promptly collecting the cacao puree and placing it in a container; and promptly freezing the cacao puree to form a frozen cacao puree. Preferably, 70%-98% of the cacao pulp and mucilage is separated from the cacao seeds, and most preferably, 80%-98% of the cacao pulp and mucilage is separated from the cacao seeds. The frozen cacao puree can be thawed and pasteurized for use in a beverage or other food product.

### BRIEF DESCRIPTION OF THE DRAWINGS

FIG. 1 is flowchart showing the steps of the process of the current invention.

FIG. 2 is a cross-sectional view of a paddle separator used in the process of the current invention.

### DETAILED DESCRIPTION OF THE INVENTION

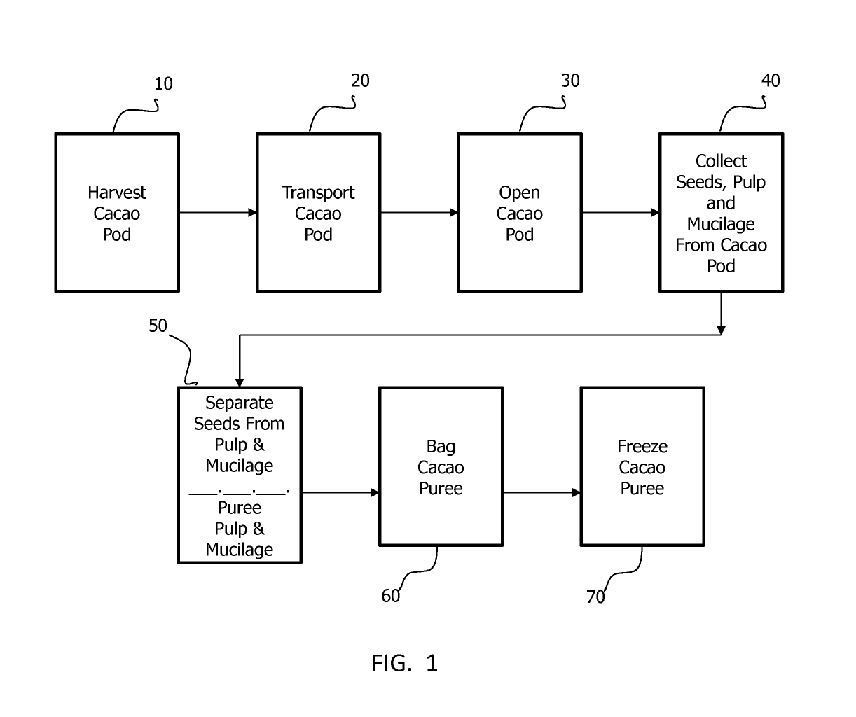

In accordance with the invention, processing of cacao pods takes place in a sanitary facility. Referring to the flowchart of FIG. 1, selected, adequately ripe and disease-free cacao pods are harvested at a cacao plantation and/or purchased from local growers at 10. The selected unopened pods are transported at 20 to the sanitary facility. The cacao pods are rinsed with water, and further cleaned as needed. The cleaned cacao pods are opened at 30 under sanitary conditions by workers wearing rubber gloves and using clean, uncontaminated cutting tools, such as clean machetes. A clean stainless steel platform or table may be used to position the pods for cutting. Opening the pods at a sanitary location (instead of in the plantation forest) minimizes the likelihood of the pulp and mucilage becoming contaminated with microorganisms.

The pulp and mucilage covered seeds is collected and placed into clean, sanitary containers at 40. The seeds and pulp and mucilage are then promptly placed in a separator machine to separate pulp and mucilage from the seeds at 50. The separator, also known as an extractor, finisher, pulper, or refiner, may take the form of a paddle separator or a screw separator. Such machines separate liquids and solids by removing relatively larger particles, including seeds, from the puree and juice of a fruit.

Screw separators have a screw or auger surrounded by a cylindrical or conical screen. The rotating auger drives the food product forwardly and also against the screen. Liquids and small particles pass through the screen and are collected while larger solids are carried by the auger to the discharge end of the screen. A discharge end port or valve provides back pressure to help force the juice portion through the screen. One exemplary screw separator is disclosed in U.S. Pat. No. 3,370,527, the disclosure of which is hereby incorporated by reference

Paddle separators have a cylindrical screen with a rotating central axle on which paddle blades are affixed. The blades sweep around the cylindrical screen and pulp and mucilage is extruded through the screen while seeds are carried to an exit. One exemplary paddle separator is disclosed in U.S. Pat. No. 5,598,772, the disclosure of which is hereby incorporated by reference.

In a preferred embodiment, the pulp and mucilage are removed from the seed using a paddle separator 100, described in more detail below. The seed bunch, which includes the seeds, mucilage and pulp is taken from the sanitary containers and fed into the paddle separator. The seed bunch is transported from the inlet by a screw feed mechanism to a pulp separating zone. The blades of the paddle separator interact with a cylindrical sieve to gently separate the pulp and mucilage from the seeds of the fruit without causing damage to the seeds. The treated seeds exit from the paddle separator seed outlet and are left with a consistent amount of pulp and mucilage. The separated pulp and mucilage are processed into a homogenized puree, which is collected at a puree output.

The separator separates pulp and mucilage from the seeds, leaving a portion of the pulp and mucilage on the seeds. The separated pulp and mucilage will be 60% or more, or more preferably 70% or more, or most preferably 80% or more, up to 98% of the pulp and mucilage originally on the seeds. Thus, the desirable amount of separation of pulp and mucilage is 60%-98%, more preferably 70%-98%, and most preferably 80%-98% of the pulp and mucilage on the seeds. In one commercial acceptable embodiment, 80%-90% of the pulp and mucilage is removed from the seeds The amount of pulp and mucilage remaining on the seeds may be an amount sufficient to permit the necessary cacao seed fermentation, but it is not necessary that the amount be sufficient to support fermentation, because the fermentation may be enabled by a cocoa pulp simulation media treated with a starter culture as described below.

The amount of separation is determined by the residence time of the cacao seeds in the separator (which is in turn determined by the angle of the blades to the axis of the central axle); and by the rotational speed of the paddles or screw. Higher percentages of separation are obtained with longer residence times and higher rotational speeds; lower percentages of separation are obtained with shorter residence times and lower rotational speeds.

The separator homogenizes the separated pulp and mucilage into a puree at 50, which is collected as it flows out of the separator. The collected cacao puree is periodically tested for purity and quality, including testing of pH, microbial content, sugar content (degrees Brix) (° Bx), and product color and odor.

The collected cacao puree is promptly packaged in sterile containers, such as sterile sealed plastic bags, at 60. Bag size will be selected depending on the intended market for the product. For consumer purchasers, smaller 2-4 liter bags will be used. For bulk purchasers, the cacao puree is packaged in plastic bags or bladders sized to hold about 30 kilograms of cacao puree, e.g. 40-50 liter bags. The bags of packaged cacao puree are then promptly frozen at 70 to prevent spoilage. Freezing can be accomplished in a conventional freezer but superior results are obtained by freezing in a freezing tunnel. One optional freezing tunnel embodiment is an IQF (individually quick frozen) freezing tunnel available from a number of manufacturers. The 30 kg bulk bags will typically be frozen at −18° C. over a 12-24 hour period. In one preferred embodiment, the bags are placed in molds before freezing to the frozen bags will be shaped to fit exactly into particular cardboard boxes or other packaging. Once the freezing step is complete, the bags are moved to a storage freezer and maintained at typical storage freezer temperatures.

In the above process, each step occurs promptly upon the conclusion of the prior step, so that the cacao puree has minimal exposure to air, thus preventing undesirable oxidation or microbial alteration of the product. As used herein, “promptly” means that there is a time period of less than 2 hours, more preferably a time period of less than one hour, and even more preferably a time period of less than 30 minutes, and most preferably, a time period of less than 10 minutes, between each step. The above described process provides a cacao pulp which is smooth, sanitary, with little or no oxidation or degradation of the cacao pulp and its healthful vitamins, antioxidants, polyphenols and other nutrients.

The removal of part of the pulp and mucilage from the cacao seed does not interfere with seed fermentation. The reduction of pulp before fermentation increases the quality of cacao beans because the acidity produced during fermentation is reduced. The separator prepares the seeds for fermentation by removing part of the pulp from the seeds, resulting in seeds having a higher amount of fructose, aroma compounds, aroma precursors, ester-precursors, free amino acids, aromatic bioactive molecules, alkaloid compounds, sugars, carbohydrates, and enzymes. In a preferred embodiment, the processed cacao seeds are fermented using a cocoa pulp simulation media treated with a starter culture, for example, a mixture of specific strains of lactic acid bacteria and acetic acid bacteria. It has been found that cacao seeds with a reduced pulp and mucilage content, e.g. about 10% of the original content, when fermented with a cocoa pulp simulation media, provide cacao beans of a more uniform and consistent high quality as compared to cacao seeds fermented using traditional techniques.

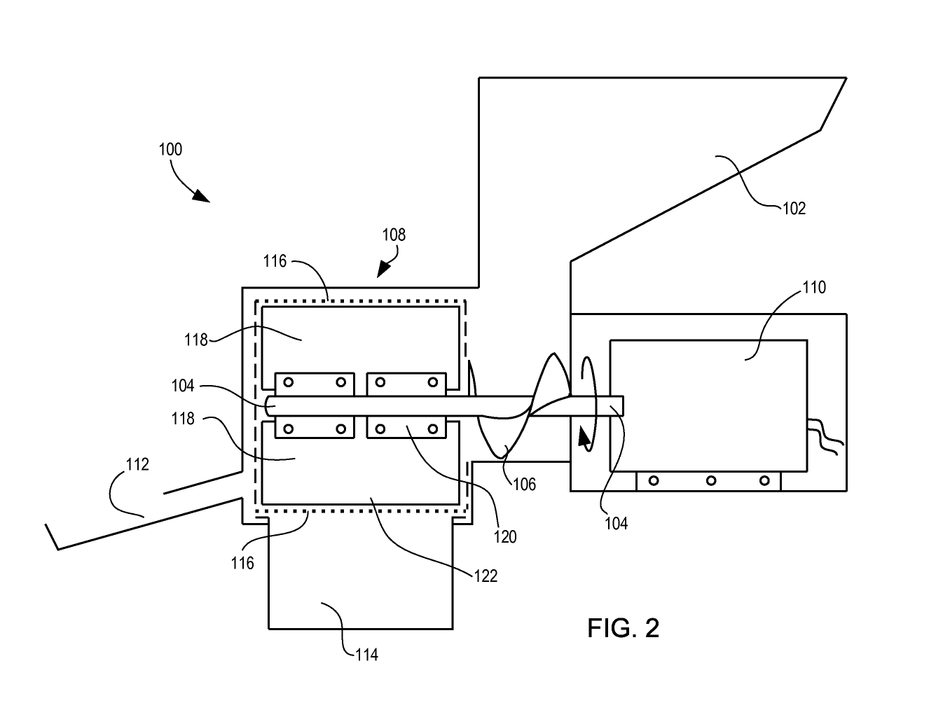

In the preferred embodiment, shown in FIG. 2, the paddle separator 100 is the separator shown in our U.S. Provisional Patent Application 61/642,128, the disclosure of which is hereby incorporated by reference, and to which we claim priority under 35 U.S.C. §119. The separator has a bin 102, a shaft 104 including a spiral feeding mechanism 106 and a pulp separating mechanism 108, a motor 110, and a seed output 112 and a puree output 114. The bin 102 may be attached to the top of the paddle separator 100 and may have an opening where pulp and mucilage-covered seeds are deposited for processing. Seeds, pulp and mucilage are fed into the separator via the feeding bin, which is preferably removable for ease of assembling and cleaning. The bin guides the pulp covered seeds toward a spiral feed mechanism 106, such as a rotating screw or spiral blades as shown in FIG. 2, that advance the pulp and mucilage to the pulp separating mechanism 108. The pulp separating mechanism 108 includes a horizontal cylindrical sieve 116 (drum sieve) containing the horizontal rotating shaft 104 with one or more wiper blades 118 mounted on the shaft. Specifically, the pulp separating mechanism may comprise two to twelve blades 118. The blades may be mounted at different positions on the shaft. The blades rotate with the rotating shaft. Alternatively, the blades may be separate from the shaft and may rotate independently from the shaft. The blades may be positioned on the shaft at an angle between 0° and 90° degrees to the central axis of the shaft, provided that at least some blades are positioned on the shaft at an angle between 3° and 87° to the central axis of the shaft to provide forward movement to the seeds. In a preferred embodiment, a blade is attached at a 15° angle to the central axis of the shaft. The angle of inclination of the blades will be selected to optimize separation of pulp and mucilage from the seeds without damaging the seeds. The blades rub the seeds against the cylindrical sieve and against each other to remove the pulp and mucilage without damaging the seed. The blades may have a smooth, rough or serrated side and may be separated at equal or unequal distances from each other. Additionally, the blades may have grooves on them or may be slightly curved. One side of the blade may be larger than the other side of the blade. The pulp separating mechanism may cause the seeds to flow from right to left or left to right. The blades may form a “V” shape with the shaft, allowing the seeds to pass both above and below the blades. The blades may have depressions or perforations arranged to intercept the pulp while also aiding in scrubbing the seeds. Coarse, fine or slicing type blades may be used. The blades may cause the seeds to grind against each other and disintegrate the pulp. The blades may have sharp edges that are sharp enough to cut through the mucilage but dull enough not to damage the seeds. The size of the blades may be 2.5 cm by 20 cm by 1 cm. In an exemplary embodiment, the blades are steel blades 120 with a soft plastic or elastic acrylate, rubber or polymer blade edge 122 affixed to one or both sides of the blades. The elastic blade edge may be attached to just one side of each blade, the side that is most in contact with the seeds to push them against the cylindrical sieve and against each other. The elastic blade edges may be removable so they can be individually cleaned and replaced. The blade edges may be affixed by screws or other fasteners to the blades.

The cylindrical sieve 116 has a number and size of the holes which is optimized for removing pulp and mucilage from cacao seeds. The cylindrical sieve 116 may be made of screen or mesh, or a perforated metal. The sieve may have round holes having diameters of two millimeters. The holes may also be of different sizes. The holes may be elongated or may have different geometries. The cylindrical sieve may further comprise a grater or shredder to help break the pulp into small pieces. The grater slots may vary in shape, number and size. Additionally, teeth like structures may be provided on the surface of the cylindrical sieve to help detach the pulp and mucilage. The teeth may be set at different angles and may be of different heights and sharpness. The cylindrical sieve 116 may resemble a rasp grater having very fine metal teeth or grooves that cut through the pulp. The cylindrical sieve may also include protrusions that simulate a fork with straight or curved ends. The protrusions may aid in removing the pulp from the seeds. The seeds are impelled by the blades, causing the seeds to rub against the sieve, blades and each other, releasing pulp and mucilage that are pushed through the sieve.

The cylindrical sieve 116 may be of any appropriate size. In one exemplary embodiment, the cylindrical sieve is 30 cm long by 12 cm height.

In one exemplary embodiment, both the blades and the cylindrical sieve may rotate. The blades may rotate in the same or in a different direction as the cylindrical sieve, e.g., the blades may rotate in a clockwise direction while the cylindrical sieve may rotate in an anti-clockwise direction. The cylindrical sieve rotation may be fast enough to create a centrifugal force that will throw the seeds outward. In an alternative embodiment, the cylindrical sieve and blades are not mounted on the same axle. Having the cylindrical sieves and blades not mounted on the same axle may allow either the blades or the cylindrical sieve to remain firmly in place and stay substantially motionless, while the blades or the cylindrical sieve rotates. Additionally, this arrangement may allow the blade or the cylindrical sieve to rotate at a different speed from each other or from the feeding mechanism. As such, the puree separator may be designed with blades or a cylindrical sieve that do not rotate. For example, when the cylindrical sieve does not rotate, the blades may rotate, and when the cylindrical sieve rotates, the blades may be stationary. The speed of rotation of the blades and cylindrical sieve may depend on the fruit that is being processed.

The puree separator machine may be powered by a motor 110. The motor may be a ⅛ to 20 horse power motor that may cause the rotating parts of the puree separator to revolve. For example, the motor may cause the axle, i.e., the shaft that includes the spiral feeding mechanism and the pulp separating mechanism, to rotate. The shaft may be connected directly to the motor or by a belt and pulley system. The motor may use pulleys with bands and gears to cause the spiral feeding mechanism, pulp separating mechanism and cylindrical sieve to rotate around a central axis. A motor may use a pulley with double bands. Some of the puree separator parts, such as the cylindrical sieve, rotating screw and pulp separating mechanism, may be driven via a belt or a pulley at a relatively low speed of about 100 revolutions per minute. In an exemplary embodiment, the shaft may be 3 cm in diameter by 80 cm long. The puree separator machine may output fifty hundred weight (“cwt”) seeds per hour and may be powered by a 220 volt power supply. The puree separator may remove up to 98% of the pulp and mucilage without injuring the seeds.

The puree separator includes two separate outputs, a seed output 112 for the seeds and a puree output 114 for the mucilage and pulp. The puree separator machine ejects the processed seeds through the seed output 112. A seed ejection shield may be located outside of the seed output. The seed ejection shield channels the seeds to the collection container, preventing the random dispersion of seeds, i.e., preventing the seeds from being ejected in different directions as they exit the separator. The pulp and mucilage are processed and homogenized by passing through the sieve to form a cacao puree, which drops down from the sieve by gravity and is collected in a channel or chute and flows out of the puree output 114.

In an exemplary embodiment, a puree separator machine may be fabricated with a material that is both rigid enough for proper operation and is easy to clean. For example, stainless steel grade 304, with a minimum of 18% chromium and 8% nickel, combined with a maximum of 0.08% carbon may be used. A chromium-nickel austenitic alloy having corrosion and oxidation resistance may be employed. Further, the puree separator may be made of materials capable of withstanding cryogenic temperatures. The thickness of the material used to make the parts of the puree separator machine may vary depending on which component of the puree separator machine is being fabricated.

As discussed above, the separator 100 provides two outputs: cleaned cacao seeds, and a cacao puree of pulp and mucilage. The cacao seeds are subsequently processed by fermentation with a cocoa pulp simulation media. The cacao puree is promptly packaged and frozen. The frozen puree is transported in a refrigerated container to a destination.

Beverages such as smoothies may be manufactured using the frozen cacao puree. The cacao puree is thawed, mixed with water, then pasteurized at 65° C.-150° C. for 0.3-60 seconds, then re-frozen and stored for two weeks. The refrozen puree is then thawed, and mixed with additional juices is desired, and pasteurized a second time at 65° C.-150° C. for 0.3-60 seconds and bottled.

The present invention provides a cacao puree of high purity and yield and provides a process that permits cacao puree to be harvested and distributed on a commercial scale. In particular, the present invention provides a cacao puree that is sanitary and not contaminated with plantation organic matter and microbes; and which is very fresh and not fermented; and in which desirable nutrients including complex sugars, polyphenols and other antioxidants are preserved and not degraded by oxidation or microbial activity. The cacao puree and products derived therefrom are fresh and sweet and provide a healthful and desirable alternative to sodas and similar beverages.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A process for producing cacao puree, comprising:
opening a cacao pod in a sanitary facility;
removing cacao seeds and cacao pulp and mucilage from the cacao pod;
separating the cacao seeds from the cacao pulp and mucilage in a separator, wherein 60%-98% of the cacao pulp and mucilage is separated from the cacao seeds, and the removed cacao pulp and mucilage is sieved to form a cacao puree;
collecting the cacao puree and placing it in a container;
freezing the cacao puree in its container.

2. The process of claim 1, wherein 70%-98% of the cacao pulp and mucilage is separated from the cacao seeds.

3. The process of claim 1, wherein 80%-98% of the cacao pulp and mucilage is separated from the cacao seeds.

4. The process of claim 1, wherein each step occurs promptly after the completion of a prior step.

5. The process of claim 1, wherein the separator is a paddle separator.

6. The process of claim 1, wherein the container is a plastic bag and the container is located in a mold during the freezing step.

7. A process for producing cacao puree, comprising:
opening a cacao pod in a sanitary facility;
promptly removing cacao seeds and cacao pulp and mucilage from the cacao pod;
promptly separating the cacao seeds from the cacao pulp and mucilage in a separator, wherein 60%-98% of the cacao pulp and mucilage is separated from the cacao seeds, and the removed cacao pulp and mucilage is sieved to form a cacao puree;
promptly collecting the cacao puree and placing it in a container;
promptly freezing the cacao puree in its container to form a frozen cacao puree in the container.

8. The process of claim 7, wherein 70%-98% of the cacao pulp and mucilage is separated from the cacao seeds.

9. The process of claim 8, wherein 80%-98% of the cacao pulp and mucilage is separated from the cacao seeds.

10. The process of claim 7, wherein the separator is a paddle separator.

11. The process of claim 7, wherein the container is a plastic bag and the container is located in a mold during the freezing step.

12. The process of claim 11, wherein the freezing step is executed through a freezing tunnel.

13. The process of claim 12, wherein the frozen cacao puree in a plastic bag is stored in a freezer.

14. The process of claim 13, further comprising: thawing the frozen cacao puree to provide a thawed cacao puree.

15. The process of claim 14, further comprising: pasteurizing the thawed cacao puree.

16. A process for producing cacao puree, comprising:
opening a cacao pod in a sanitary facility;
promptly removing cacao seeds and cacao pulp and mucilage from the cacao pod;
promptly separating the cacao seeds from the cacao pulp and mucilage in a paddle separator, wherein 60%-98% of the cacao pulp and mucilage is separated from the cacao seeds, and the removed cacao pulp and mucilage is sieved through a cylindrical sieve of the paddle separator to form a cacao puree;
promptly collecting the cacao puree and placing it in a plastic bag;
promptly placing the plastic bag in a mold;
promptly placing the mold with the plastic bag in a freezing tunnel to freeze the cacao puree to form a frozen cacao puree.

17. The process of claim 16, wherein 70%-98% of the cacao pulp and mucilage is separated from the cacao seeds.

18. The process of claim 17, wherein 80%-98% of the cacao pulp and mucilage is separated from the cacao seeds.

19. The process of claim 16, further comprising: thawing the frozen cacao puree to provide a thawed cacao puree.

20. The process of claim 19, further comprising: pasteurizing the thawed cacao puree.
